(19) United States
(12) Patent Application Publication
(10) Pub. No.: US 2020/0178585 A1
(43) Pub. Date: Jun. 11, 2020

(54) SAVOURY CONCENTRATE WITH MULBERRY FRUIT EXTRACT

(71) Applicant: Conopco, Inc., d/b/a UNILEVER, Englewood Cliffs, NJ (US)

(72) Inventors: Michel MELLEMA, Woerden (NL); Jacobus Wiebren SEUEN-TEN-HOORN, 3133 AT Vlaardingen (NL); Petra VERHOEF, Bergschenhoek (NL)

(73) Assignee: Conopco, Inc., d/b/a UNILEVER, Englewood Cliffs, NJ (US)

(21) Appl. No.: 16/309,273

(22) PCT Filed: Jun. 15, 2017
(86) PCT No.: PCT/EP2017/064679

§ 371 Date: Dec. 12, 2018

(30) Foreign Application Priority Data
Jun. 21, 2016 (EP) 16175455.1

(51) Int. Cl. A23L 27/12; A23L 27/00; A23L 23/10

(52) U.S. Cl. CPC A23L 27/12; A23L 23/10; A23L 27/88

(57) ABSTRACT

The invention relates to a process of preparing a savoury concentrate, such as a bouillon cube or a seasoning, which comprises a mulberry fruit material. These savoury concentrates are particularly suitable for use as a cooking aid in the preparation of starch rich food comprising at least 60% of starch by weight of dry matter. The invention further relates to a savoury concentrate and to a method of preparing starch rich food comprising at least 60% of starch by weight of dry matter.

### FIELD OF THE INVENTION

The invention relates to a process of preparing a savoury concentrate, such as a bouillon cube or a seasoning, which comprises a mulberry fruit material. These savoury concentrates are particularly suitable for use as a cooking aid in the preparation of starch rich food. The invention further relates to a savoury concentrate and to a method of preparing starch rich food. The invention also relates to a food kit comprising the savoury concentrate and a starch rich food product.

### BACKGROUND OF THE INVENTION

Savoury concentrates, such as bouillon cubes, are widely used in the preparation of bouillon, soup, sauce or gravy.

The most common physical formats in which savoury concentrates are available are powders, granulates, pastes, cubes or tablets.

The powders can be prepared by mixing all ingredients in the proper proportion, optionally followed by granulating to obtain granulates using equipment known in the art. The powders and granulates are generally offered in sachets or jars.

The conventional bouillon and seasoning cubes are prepared by mixing the ingredients, followed by pressing the mixed ingredients to a cube. Alternatively, cubes or tablets can be prepared by mixing all ingredients followed by extruding and cutting the extrudate. The cubes or tablets are usually individually wrapped and packed in a box.

In, for instance, South-America savoury concentrates are widely used as a cooking aid in the preparation of starch rich foods, such as rice or pasta. The savoury concentrate is added to the cooking water while cooking the starch rich food or is sprinkled as a seasoning on the starch rich food after cooking. The obtained cooked starch rich food has an enhanced flavour due to the addition of the cooking aid.

Mulberries (or Morus) are a genus of flowering plants in the family Moraceae, growing wild and under cultivation in many temperate world regions. The mulberry fruit is a multiple fruit and about 2-3 cm long.

One of the mulberry species is the white mulberry (Morus alba). The fruits of the species in the wild are deep purple, but in many cultivated plants the colour of the plants varies from white to pink. The taste of the fruits is sweet but bland, unlike the more intense flavor of the red mulberry (Morus rubra) and black mulberry (Morus nigra).

WO 01/72148 describes a cooking aid composed of an envelope based on fat which is solid at room temperature and a fluid or pasty flavouring filling. The cooking aid has good mechanical resistance to handling at room temperature and melts rapidly upon contact with food or a kitchen utensil which is hot, which allows rapid dissolution and dispersion of the filling. Especially, in the case of seasoning cooked pasta, rice or vegetables, the fatty coating melts rapidly, releasing the fluid filling which becomes rapidly distributed in the meat and vegetable dish.

### SUMMARY OF THE INVENTION

It has been surprisingly found that savoury concentrates containing a mulberry fruit material can advantageously be used in the preparation of starch rich food, e.g. pasta, especially if the food is prepared from high refined starch material (e.g. flour or white rice). By applying the savoury concentrate of the present invention as a cooking aid in the preparation of cooked starch rich food, taste, mouthfeel and appearance of these cooked foods can be significantly enhanced, rendering the food more appealing to consumers.

The inventors have found that savoury concentrates of the present invention are capable of imparting desirable sensory attributes to cooked foods, such as firm mouthfeel, bitter taste, and sourdough/rye-bread flavor. Additionally, the savoury concentrate of the present invention is capable of enhancing desirable flavour notes such as whole-wheat flavor. These benefits are associated with the application of the mulberry fruit material in a concentration of 5-50% by weight of the savoury concentrate.

Thus, one aspect of the present invention pertains to process of preparing a savoury concentrate, said process comprises the combining of the following components:
a) 15-85% by weight of the savoury concentrate of inorganic salts;
b) 5-50% by weight of the savoury concentrate of a mulberry fruit material;
c) 0-60% by weight of the savoury concentrate of fat;
d) 0-25% by weight of the savoury concentrate of glutamate compound;
e) 0-25% by weight of the savoury concentrate of starch component selected from native starch, pre-gelatinised starch, maltodextrin, modified starch and combinations thereof;
f) 0-20% by weight of the savoury concentrate of sugars selected from monosaccharides, disaccharides and combinations thereof;
g) 0-45% by weight of the savoury concentrate of vegetable matter selected from vegetables, herbs, spices and combinations thereof;
h) 0-10% by weight of the savoury concentrate of water;
   wherein the combination of components a) to e) is applied in an amount representing at least 55 wt. % of the weight of the savoury concentrate and wherein the combination of components a) to h) is applied in an amount representing at least 75 wt. % of the weight of the savoury concentrate.

The invention further pertains to a savoury concentrate that is obtainable by the above process and to a method for preparing a cooked starch rich food product comprising at least 60 wt. % of starch by weight of dry matter of the starch rich food product, such as pasta, rice, noodles, couscous, quinoa and others. The invention also relates to a food kit comprising the savoury concentrate and a starch rich food product.

The mulberry fruit material can be added to savoury concentrates such as a bouillon cube or a seasoning product. Both products are suitable for addition to the cooking water during the cooking of the starch rich food or are suitable for addition to the cooked starch rich food, wherefore the bouillon cube needs to be crumbled first, and the seasoning can be added as such.

### DETAILED DESCRIPTION OF THE INVENTION

A first aspect of the present invention relates to a process of preparing a savoury concentrate, said process comprises the combining of the following components:
a) 15-85% by weight of the savoury concentrate of inorganic salts;
b) 5-50% by weight of the savoury concentrate of a mulberry fruit material;
c) 0-60% by weight of the savoury concentrate of fat;
d) 0-25% by weight of the savoury concentrate of glutamate compound;
e) 0-25% by weight of the savoury concentrate of starch component selected from native starch, pre-gelatinised starch, maltodextrin, modified starch and combinations thereof;
f) 0-20% by weight of the savoury concentrate of sugars selected from monosaccharides, disaccharides and combinations thereof;
g) 0-45% by weight of the savoury concentrate of vegetable matter selected from vegetables, herbs, spices and combinations thereof;
h) 0-10% by weight of the savoury concentrate of water;
   wherein the combination of components a) to e) is applied in an amount representing at least 55 wt. % of the weight of the savoury concentrate and wherein the combination of components a) to h) is applied in an amount representing at least 75 wt. % of the weight of the savoury concentrate.

The term “mulberry fruit material” refers to a material obtained from the fruit of the Mulberry, Morus.

The term “fat” as used herein refers to glycerides selected from triacylglycerides, diacylglycerides, monoacylglycerides, phosphoacylglycerides and combinations thereof. The term “fat” encompasses fats that are liquid at ambient temperature as well as fats that are solid or semi-solid at ambient temperature.

The term “glutamate compound” as used herein refers to glutamic acid, edible glutamate salts and combinations thereof.

The term “particulate matter” as used herein refers to powder or to a granulate where the powder is granulated.

The savoury concentrate of the present invention can take the form of a shaped product, a paste or the form of particulate matter, such as a powder or a granulate. Preferably, the savoury concentrate is in the form of particulate matter or a shaped product. More preferably the savoury concentrate is in the form of particulate matter.

The savoury concentrate of the present invention preferably comprises 20-85% by weight of the savoury concentrate of inorganic salts, more preferably comprises 30-80%, and most preferably 35-75% by weight of the savoury concentrate of inorganic salts.

The inorganic salts in the savoury concentrate are preferably selected from sodium chloride, potassium chloride and combinations thereof. More preferably, the inorganic salt is sodium chloride.

The savoury concentrate of the present invention preferably comprises 6-45% by weight of the savoury concentrate of mulberry fruit material, more preferably comprises 7-40%, and most preferably 8-35% by weight of the savoury concentrate of mulberry fruit material.

The mulberry fruit material in the savoury concentrate is preferably selected from mulberry fruit, mulberry fruit extracts and combinations thereof. Mulberry fruit is preferably applied in dried form, more preferably in dried, ground form. The mulberry fruit material that is employed in accordance with the present invention can be a solid product, a paste or a liquid. Preferably, the mulberry fruit material is a dry solid product.

In the present invention, the preferred mulberry fruit material is a mulberry fruit extract. More preferably the extract is an aqueous mulberry fruit extract, most preferably the extract is a dried extract obtained from an aqueous mulberry fruit extract.

Preferably at least 80 wt. % of the dry matter of the mulberry fruit extract obtained from an aqueous mulberry fruit extract dissolves when the material is added to demineralized water at a temperature of 20° C. in a concentration providing 20 gram of dry matter per litre.

A dried mulberry fruit extract obtained from an aqueous mulberry fruit extract, which can be used in accordance with the present invention, may suitably be obtained as follows: dried mulberry fruit is sliced, extracted with water, filtered and concentrated, and finally dried (e.g. by spray-drying) into fine powder. No excipient needs to be used during such spray-drying process, resulting in a final product with a dried mulberry fruit to dried extract ratio of e.g. 10:1.

The mulberry fruit material preferably comprises 0.1-15% iminosugars by dry weight of the mulberry fruit material, wherein these iminosugars preferably comprise 1-Deoxynojirimycin (DNJ). More preferably the iminosugars comprise 1-Deoxynojirimycin (DNJ) and further one or more of fagomine, N-methyl-DNJ,1,4-dideoxy-1,4-imino-D-arabinitol (DAB), 2-O-α-D-galactopyranosyl-DNJ (GAL-DNJ), calystegin B.

More preferably the mulberry fruit material comprises 0.2-10% by dry weight of the savoury concentrate of said iminosugars. Most preferably, the mulberry fruit material comprises 0.4-5% by dry weight of the savoury concentrate of said iminosugars.

The mulberry fruit material is preferably obtained from the fruit of the Morus Alba, Morus nigra or Morus rubra. More preferably the mulberry fruit is obtained from the fruit of the Morus Alba or Morus rubra. Most preferably the mulberry fruit is obtained from the fruit of the Morus Alba.

In the savoury concentrate according to the present invention, the inorganic salts and the mulberry fruit material are preferably applied in a weight ratio in the range of 1:3 to 16:1. More preferably the inorganic salts and the mulberry fruit material are applied in a weight ratio in the range of 1:2 to 12.5:1.

The savoury concentrate of the present invention preferably comprises 0.1-40 wt. % by weight of the savoury concentrate of fat, more preferably comprises 0.2-35%, and most preferably 0.4-30% by weight of the savoury concentrate of fat.

The fat employed in the savoury concentrate preferably is a vegetable fat. The term “vegetable fat” encompasses vegetable fats that have been fractionated and/or hydrogenated. Examples of vegetable fats that may suitably be used in the savoury concentrate include palm oil, palm kernel oil, coconut oil, sunflower oil, soybean oil, rapeseed oil, linseed oil, cottonseed oil, maize oil, olive oil and combinations thereof.

The savoury concentrate of the present invention preferably comprises 0.2-24% by weight of the savoury concentrate of glutamate compound, more preferably comprises 0.4-23%, and most preferably 0.8-22% by weight of the savoury concentrate of glutamate compound.

The glutamate compound in the savoury concentrate is preferably selected from glutamic acid, edible glutamate salts and combinations thereof. Suitable sources of a glutamate compound include yeast extracts, yeast auto-lysates, hydrolysed vegetable protein and combinations thereof.

The savoury concentrate of the present invention preferably comprises 0.1-20% starch compound by weight of the savoury concentrate, more preferably comprises 0.2-15%, and most preferably 0.4-10% by weight of the savoury concentrate of starch compound.

The starch compound in the savoury concentrate is selected from native starch, pre-gelatinised starch, maltodextrin, modified starch and combinations thereof. Even more preferably, the starch is selected from native starch, pre-gelatinised starch and combinations thereof. Most preferably, the starch component is native starch.

The savoury concentrate of the present invention preferably comprises 0.1-15% by weight of the savoury concentrate of sugars, selected from monosaccharides, disaccharides and combinations thereof. More preferably, the savoury concentrate comprises 0.2-10%, and most preferably 0.4-8% by weight of the savoury concentrate of these sugars.

Preferably, the aforementioned sugars are selected from sucrose, glucose, fructose, lactose and combinations thereof.

The savoury concentrate of the present invention preferably comprises 0-45% by weight of the savoury concentrate of vegetable matter originating from a vegetable source selected from vegetables, herbs, spices and combinations thereof. More preferably, the savoury concentrate comprises 0.01-35%, and most preferably 0.02-25% by weight of the savoury concentrate of vegetable matter.

Examples of sources of vegetable matter include parsley, dill, basil, chives, sage, rosemary, thyme, oregano, curcuma, leek, garlic, onion, pepper, celery, mushrooms, broccoli, cauliflower, tomato, courgette, asparagus, bell pepper, eggplant, cucumber, carrot, coconut flesh, galangal, ginger, lemon grass, and turnips. The vegetable matter may be applied in the form of leafs, slices, florets, dices or other pieces.

The savoury concentrate of the present invention preferably comprises 0-8 wt. % of water by weight of the savoury concentrate. More preferably, the savoury concentrate of the present invention comprises 0.5-5 wt. % and most preferably the savoury concentrate comprises 1-3 wt. % of water by weight of the savoury concentrate.

In a preferred embodiment, a part of the salt of the savoury concentrate is dissolved in the water of the savoury concentrate, wherein at least 0.15 g salt is dissolved per ml of water.

Besides the components indicated above, the savoury concentrate of the present invention may suitably contain additional ingredients, such as taste enhancers, gelatine, binders, emulsifiers (e.g. lecithin and/or monoglycerides), flavouring, colouring agents, minerals, vitamins and combinations thereof.

The process of preparing a savoury concentrate of the present invention, preferably comprises the application of the components a) to e) in an amount representing at least 60 wt. %, more preferably at least 65 wt. %, of the savoury concentrate and the application of the components a) to h) in an amount representing at least 80 wt. % of the savoury concentrate.

In a preferred embodiment of the present process, the combined components are converted into granules or shaped articles.

The savoury concentrate mixture may suitably be converted into granules by means of fat based granulation followed by shaping by compression or water based granulation, e.g. using a fluidized bed.

The savoury concentrate mixture may suitably be converted into shaped articles by means of compression. The compressing of the savoury concentrate mixture can be done using equipment known in the art. Examples of known techniques that can be used to form the shaped articles include tabletting, roller compacting, extrusion, pelletising, etc.

In a particularly preferred embodiment of the invention, the process yields a savoury concentrate in the form of particulate matter, wherein the process comprises combining:
a) 45-85% by weight of the savoury concentrate of inorganic salts;
b) 5-35% by weight of the savoury concentrate of mulberry fruit material;
c) 0.1-30% by weight of the savoury concentrate of fat;
d) 0.2-25% by weight of the savoury concentrate of glutamate compound;
e) 0.1-45% by weight of the savoury concentrate of vegetable matter selected from vegetables, herbs, spices and combinations thereof.

In a more preferred embodiment of the invention, the savoury concentrate in the form of particulate matter, is prepared by a process that comprises combining:
a) 55-85% by weight of the savoury concentrate of inorganic salts;
b) 5-35% by weight of the savoury concentrate of mulberry fruit material;
c) 0.2-5% by weight of the savoury concentrate of fat;
d) 0.4-15% by weight of the savoury concentrate of glutamate compound;
e) 1-20% by weight of the savoury concentrate of starch component selected from native starch, pre-gelatinised starch, maltodextrin, modified starch and combinations thereof;
f) 0.1-15% by weight of the savoury concentrate of sugars selected from monosaccharides, disaccharides and combinations thereof;
g) 0.2-35% by weight of the savoury concentrate of vegetable matter selected from vegetables, herbs, spices and combinations thereof.

In a most preferred embodiment of the invention, the savoury concentrate in the form of particulate matter, is prepared by a process that comprises combining:
a) 60-85% by weight of the savoury concentrate of inorganic salts;
b) 5-35% by weight of the savoury concentrate of mulberry fruit material;
c) 0.5-3% by weight of the savoury concentrate of fat;
d) 0.8-15% by weight of the savoury concentrate of glutamate compound;
e) 2-10% by weight of the savoury concentrate of starch component selected from native starch, pre-gelatinised starch, maltodextrin, modified starch and combinations thereof;
f) 0.4-10% by weight of the savoury concentrate of sugars selected from monosaccharides, disaccharides and combinations thereof;
g) 0.4-25% by weight of the savoury concentrate of vegetable matter selected from vegetables, herbs, spices and combinations thereof.

The savoury concentrate in the form of particulate matter is even more preferably concerted into the form of a granulate having a mass weighted average diameter in the range of 0.1-2.5 mm. More preferably, the granulate has a mass weighted average diameter in the range of 0.2-2 mm, most preferably in the range of 0.25-1.5 mm.

The mass weighted mean diameter of the savoury concentrate in granulated form may suitably be determined using a set of sieves with different mesh sizes in case at least 80 wt. % of the material has a diameter of more than 100 μm.

In another embodiment of the present process, the process yields a savoury concentrate in the form of a shaped product having a weight of 2-50 g, said process comprising combining:
a) 20-65% by dry weight of the shaped product of inorganic salts;
b) 10-50% by weight of the shaped product of mulberry fruit material;
c) 5-60% by weight of the shaped product of fat;
d) 0.2-25% by weight of the shaped product of glutamate compound;
e) 0.5-10% by weight of sugars selected from monosaccharides, disaccharides and combinations thereof.

More preferably, the savoury concentrate in the form of a shaped product is prepared by a process that comprises combining:
a) 30-60% by weight of the shaped product of inorganic salts;
b) 15-45% by weight of the shaped product of mulberry fruit material;
c) 10-40% by weight of the shaped product of fat;
d) 0.5-20% by weight of the shaped product of glutamate compound;
e) 0.1-15% by weight of the savoury concentrate of starch component selected from native starch, pre-gelatinised starch, maltodextrin, modified starch and combinations thereof;
f) 1-8% by weight of the shaped product of sugars selected from monosaccharides, disaccharides and combinations thereof;
g) 0.01-10% by weight of the savoury concentrate of vegetable matter selected from vegetables, herbs, spices and combinations thereof.
h) 0.1-5% by weight of the savoury concentrate of water.

Most preferably, the savoury concentrate in the form of a shaped product is prepared by a process that comprises combining:
a) 35-50% by weight of the shaped product of inorganic salts;
b) 12-40% by weight of the shaped product of mulberry fruit material;
c) 15-35% by weight of the shaped product of fat;
d) 0.5-15% by weight of the shaped product of glutamate compound;
e) 0.2-10% by weight of the savoury concentrate of starch component selected from native starch, pre-gelatinised starch, maltodextrin, modified starch and combinations thereof;
f) 1.5-6% by weight of the shaped product of sugars selected from monosaccharides, disaccharides and combinations thereof;
g) 0.02-5% by weight of the savoury concentrate of vegetable matter selected from vegetables, herbs, spices and combinations thereof.
i) 0.2-3% by weight of the savoury concentrate of water.

The shaped product preferably has a weight in the range of 2.5-30 g, more preferably in the range of 3.0-28 g and most preferably of 3.2-24 g.

The shaped product can suitably be provided in different forms. Preferably, the shaped product is provided in the form of a cuboid, more preferably in the form of a rectangular cuboid and most preferably in the form of a cube.

The process of preparing a savoury concentrate of the present invention, wherein the process preferably comprises packaging of the savoury concentrate in a container, sachet or wrapper.

A second aspect according to the invention relates to savoury concentrate comprising the following components:
a) 15-85% by weight of the savoury concentrate of inorganic salts;
b) 5-50% by weight of the savoury concentrate of mulberry fruit material;
c) 0-60% by weight of the savoury concentrate of fat;
d) 0-25% by weight of the savoury concentrate of glutamate compound;
e) 0-25% by weight of the savoury concentrate of starch component selected from native starch, pre-gelatinised starch, maltodextrin, modified starch and combinations thereof;
f) 0-20% by weight of the savoury concentrate of sugars selected from monosaccharides, disaccharides and combinations thereof;
g) 0-45% by weight of the savoury concentrate of vegetable matter selected from vegetables, herbs, spices and combinations thereof;
h) 0-10% by weight of the savoury concentrate of water;
   wherein the components a) to e) together represent at least 55 wt. % of the savoury concentrate and wherein the components a) to h) together represent at least 75 wt. % of the savoury concentrate.

The preferred embodiments described herein in relation to the present process of preparing a savoury concentrate also apply to the savoury concentrate itself.

The mulberry fruit material in the savoury concentrate of the present invention preferably comprises iminosugars, as described herein before in relation to the present process of preparing a savoury concentrate. The savoury concentrate according to the present invention therefore typically comprises 0.005-7.5% by dry weight of the savoury concentrate of iminosugars comprising 1-Deoxynojirimycin (DNJ). More preferably the iminosugars in the savoury concentrate comprise 1-Deoxynojirimycin (DNJ) and further one or more of fagomine, N-methyl-DNJ,1,4-dideoxy-1,4-imino-D-arabinitol (DAB), 2-O-α-D-galactopyranosyl-DNJ (GAL-DNJ), calystegin B.

More preferably the savoury concentrate according to the present invention comprises 0.01-5% by dry weight of the savoury concentrate of said iminosugars. Most preferably, the savoury concentrate according to the present invention comprises 0.02-2.5% by dry weight of the savoury concentrate of said iminosugars.

According to another preferred embodiment, the savoury concentrate is obtained by the process as described herein before.

A third aspect of the invention relates to method for preparing a cooked starch rich food product comprising at least 60% of starch by weight of dry matter, wherein said method comprises the addition of a savoury concentrate, as described herein before, during or after the preparation of the cooked starch rich food product.

In a preferred embodiment of the method for preparing a starch rich food product, the method comprises cooking the starch rich food product in hot cooking water and adding the savoury concentrate to the cooking water.

In another preferred embodiment, the savoury concentrate is added after the cooking of the starch rich food product.

The starch rich food product is preferably a grain, a root or a food product prepared from a starch source derived from grain, root, and combinations thereof. More preferably the starch rich food product is a grain or a food product prepared from a starch source derived from a grain. The term “grain” as used herein refers to cereal grain, pseudocereal grain and legume grain.

Examples of a cereal grain are maize, rice, wheat, barley, sorghum, millet, oats, rye, fonio, sorghum. Examples of pseudocereal grain are amaranth, guinoa and buckwheat. Examples of legume grain are lentils and beans.

Examples of a food product prepared from a starch source derived from grains are pasta, noodles, couscous and others.

The starch rich product preferably comprises at least 65% of starch by weight of dry matter and more preferably the starch rich product comprises at least 70% by weight of dry matter.

Typically, the present method comprises adding the savoury concentrate in an amount of 0.01-7% by weight of the cooked starch rich food product. More preferably, the savoury concentrate is added in an amount of 0.05-3%, most preferably of 0.1-2% by weight of the cooked starch rich food product.

A fourth aspect of the invention relates to a food kit comprising:
a savoury concentrate, as described herein before; and
a starch rich food product comprising at least 60% of starch by weight of dry matter of the starch rich food product.

Preferably, the savoury concentrate in the food kit is the form of particulate matter.

Preferably, the starch rich food product in the food kit is uncooked or partially cooked. More preferably, the starch rich food product is uncooked.

Preferably, the starch rich food product in the food kit is selected from pasta, rice, noodles, couscous, and quinoa. More preferably, the starch rich food product in the food kit is selected from pasta, rice, and noodles.

In a preferred embodiment, the food kit comprises a mixture of the savoury concentrate and the starch rich food product within the food kit.

In another preferred embodiment, the savoury concentrate and the starch rich food product are separately packaged within the food kit.

The invention is further illustrated by the following non-limiting examples.

### EXAMPLES

### Example 1

Seasoning in the form of particulate matter, i.e. powder, is prepared on the basis of the recipe (in wt. %) as shown in Table 1.

TABLE 1

| Ingredients | Wt. % |
|---|---|
| Sodium chloride | 65.5 |
| Dried mulberry fruit extract³ | 20 |
| Vegetable matter powder¹ | 7.4 |
| Mono sodium glutamate | 4.3 |
| Yeast extract² | 0.8 |
| Sugar | 0.4 |
| Other | 1.6 |

¹Contains onion and garlic powder.
²Yeast extract comprises glutamate and about 24 wt. % of NaCl.
³This mulberry fruit extract comprises about:
2 wt. % of iminosugars comprising DNJ and GAL-DNJ;
20 wt. % of amino acids;
14 wt. % of organic acids;
22 wt. % of carbohydrates;
16 wt. % of ash;
Other compounds.

The coloured ingredients are first mixed with the sodium chloride at 115 rpm until the colour is uniform in the mixture. Subsequently the remaining ingredients are added to the mixture and all ingredients are mixed together at 115 rpm in the mixer (Littleford) until an uniform mixture is obtained.

### Example 2

The seasoning powder as described in example 1 is used to prepare seasoning granules. The seasoning powder is granulated into granules by applying water based granulation using a fluidized bed system.

The granules so obtained have a mass weighted average diameter of around 1 mm.

### Example 3

Bouillon cubes are prepared on the basis of the recipe (in wt. %) as shown in Table 2.

TABLE 2

| Ingredients | Wt. % |
|---|---|
| Sodium chloride | 34 |
| Fat | 17 |
| Dried mulberry fruit ³ | 15 |
| Yeast extract¹ | 11 |
| Chicken base | 8.5 |
| Sugar & caramel | 5.6 |
| Vegetable matter ² | 2.8 |
| Potato starch | 1.7 |
| Water | 1.7 |
| Other | 2.7 |

¹Yeast extract comprises 18 wt. % of NaCl and glutamate.
² Contains rosemary, black pepper, curcuma, parsley, garlic, white onion and celery.
³ The dry matter of dried mulberry fruit comprises about:
3 wt. % of iminosugars comprising DNJ and GAL-DNJ;
12 wt. % of amino acids;
75 wt. % of carbohydrates;
3 wt. % of fat;
2 wt. % of ash;
Other compounds.

The cubes are prepared using the following procedure:
sodium chloride, yeast extract and potato starch are introduced into a mixer and mixed for 60 seconds, at 2100 rpm;
water, sugar and caramel are added and mixed for 120 s, at 1200 rpm;
dried mulberry fruit and vegetable matter is added and mixed for 30 seconds, at 3600 rpm;
fat is added and mixed of 120 seconds, at 3600 rpm.

Subsequently, the concentrate mixture is discharged from the mixer and kept 2 hours at ambient temperature to allow for fat crystallization. Next, the concentrate mixture is shaped into cubes of approximately 9.5 grams by compressing the mixture into a mould.

### Example 4

The hardness of white macaroni was measured, wherein the effect of cooking the white macaroni with and without the presence of mulberry fruit material in the cooking water was compared.

White macaroni was prepared according to following method using the ingredients in the amounts as indicated in Table 3:
1) Weigh salt and optionally the Mulberry fruit material in a weighing tub;
2) Weigh macaroni in a separate weighing tub;
3) Transfer the salt and optionally the Mulberry fruit material to a cooking pan; rinse the tub with water and add this water to the cooking pan, fill up the pan with the required amount of water;
4) Heat the cooking pan on the stove till the water starts to boil;
5) Add the macaroni to the boiling water, stir, and start timer when the water cooks again;
6) Put a lid on the cooking pan, reduce heat to simmer and boil for 9 minutes;
7) After nine minutes turn of the heat, drain excess of water through a sieve, and flush the cooked macaroni with tap water.

TABLE 3

| | | |
|---|---|---|
| Ingredients | 1 | A |

| | | | | |
|---|---|---|---|---|
| White pasta | 69 | g | 69 | g |
| (Honig, NL) | | | | |
| Water used for boiling | 260 | ml | 260 | ml |
| (tap water, NL) | | | | |

| | | |
|---|---|---|
| Sea salt | 1.79 gram | 1.79 gram |
| (Dokkumer Natuurvoeding) | (0.69 wt. % per | (0.69 wt. % per |
| | L water) | L water) |

| | | |
|---|---|---|
| Dried aqueous Mulberry | 1212 | mg |
| (Morus alba) fruit | | |
| extract¹ (Draco, US) | | |

¹This mulberry fruit extract comprises about:
2 wt. % of iminosugars comprising DNJ and GAL-DNJ;
20 wt. % of amino acids;
14 wt. % of organic acids;
22 wt. % of carbohydrates;
16 wt. % of ash;
Other compounds.

The cooked white macaroni 1 comprises 50 g of carbohydrates, 0.5% salt and 0.68% MFE with a total weight of 175 g. The cooked white macaroni A comprises 50 g of carbohydrates and 0.5% salt with a total weight of 175 g.

Hardness measurements were performed using the Texture Analyzer type XTPlus from Stable Micro Systems using method NOO2/P35. The settings of this method are indicated in table 4.

TABLE 4

| | |
|---|---|
| Settings | NOO2/P35 |
| Mode | Measure force compression |
| Option | Return to start |
| Pre-test Speed | 2.0 mm/s |
| Test Speed | 2.0 mm/s |
| Post-test Speed | 2.0 mm/s |
| Strain | 75% |
| Trigger type | Auto - 10 g |
| Tare mode | Auto |
| Data acquisition rate | 200 pps |
| Probe | 35 mm cylinder |

The hardness of the cooked macaroni 1 and A were measured at a compression strain of 75% on 1 cooked macaroni with 15 repeats. The results of these measurement are indicated in table 5. The difference in hardness between macaroni 1 and A was statistically significant (unpaired t-test, two-tailed P value=0.0011). The presence of mulberry fruit material in the cooking water during the cooking of the macaroni has an effect on the hardness of the cooked macaroni.

TABLE 5

| Hardness (g) | Average | St. dev. |
|---|---|---|
| 1 | 2016 | 146 |
| A | 1776 | 210 |

### Example 5

Macaroni's 2, B, C were prepared as described herein before in example 4, using the ingredients as indicated in Table 6.

Macaroni 3 was prepared in a similar way as Macaroni 2, except that the salt and the mulberry fruit material was not used during the cooking of the pasta, but the mixture of the salt and the mulberry fruit material was sprinkled on the macaroni after the cooking of the macaroni in the same amounts as was added to the cooking water of macaroni 2.

TABLE 6

| Ingredients | 2 ¹ | | 3 ² | | B | | C | |
|---|---|---|---|---|---|---|---|---|
| White pasta | 400 | g | 400 | g | — | | 400 | g |
| (Honig, NL) | | | | | | | | |
| Whole grain pasta | — | | — | | 400 | g | — | |
| (Honig, NL) | | | | | | | | |
| Water used for | 1.5 | L | 1.5 | L | 1.5 | L | 1.5 | L |
| boiling (tap | | | | | | | | |
| water, NL) | | | | | | | | |
| Sea salt | 10.4 | g | 10.4 | g | 10.4 | g | 10.4 | g |
| (Dokkumer | | | | | | | | |
| Natuurvoeding) | | | | | | | | |

| | | | | | | |
|---|---|---|---|---|---|---|
| Dried aqueous | 7 | g | 7 | g | — | — |
| Mulberry (Morus | | | | | | |
| alba) fruit | | | | | | |
| extract ³ (Draco, | | | | | | |
| US) | | | | | | |

¹ Macaroni 2 was prepared by adding the sea salt and the mulberry extract to the cooking water
² Macaroni 3 was prepared by sprinkling the mix of sea salt and mulberry extract on the cooked macaroni and mixing the sprinkled macaroni.
³ This mulberry fruit extract comprises about:
2 wt. % of iminosugars comprising DNJ and GAL-DNJ;
20 wt. % of amino acids;
14 wt. % of organic acids;
22 wt. % of carbohydrates;
16 wt. % of ash;
Other compounds.

The different macaroni's thus prepared were tested by a professional sensory panel of 15 persons. The sensory panel tasted the different samples in random order and was unaware of how the samples were prepared. The sensory panel scored the different sensory attributes on a score scale of 0 to 15. The results are presented in table 7. The letters in table 7 are used to indicate the following. The values with the same letter are not statistically different from each other, while the values with different letters are statistically different from each other.

TABLE 7

| Sensory attributes | 2 | | 3 | | B | | C | |
|---|---|---|---|---|---|---|---|---|
| Bitter taste | 3.47 | a | 3.10 | a | 3.17 | a | 1.57 | b |
| Sourdough/rye-bread | 5.47 | a | 3.73 | b | 2.67 | b | 0.10 | c |
| flavour | | | | | | | | |
| Whole-wheat odour | 5.30 | a | 5.63 | a | 5.47 | a | 0.53 | b |
| Whole-wheat flavour | 5.30 | a/b | 4.67 | b | 5.90 | a | 0.37 | c |
| Flour flavour | 1.57 | b | 2.13 | b | 1.53 | b | 5.43 | a |
| Fibrous mouthfeel | 2.97 | b | 2.83 | b | 5.30 | a | 0.97 | c |
| Firm mouthfeel | 6.40 | b | 6.23 | b | 7.40 | a | 5.30 | c |
| Brown colour intensity | 8.60 | a | 7.80 | a/b | 7.00 | b | 3.50 | c |
| Colour uniformity | 7.97 | a | 4.87 | b | 6.00 | b | 8.50 | a |
| Rough appearance | 2.97 | b | 5.10 | a | 5.23 | a | 3.03 | b |

Is was surprisingly found that the macaroni prepared with mulberry fruit extract in the cooking water (Macaroni 2) or with the mulberry extract sprinkled on the cooked macaroni (Macaroni 3) had several sensory attributes that were significantly changed compared to Macaroni C (white macaroni). These changed attributes were at a level similar as those tasted for Macaroni B (whole grain macaroni), or are in-between macaroni B and C, for the attributes fibrous and firm mouth feel. This is advantageous, as consumers generally appreciate the taste of wholegrain pasta's except for the fibrous mouthfeel that is typical for whole grain pasta.

Macaroni 3 also shows that by sprinkling the mulberry fruit extract on the cooked pasta an additional effect is obtained: the macaroni 3 appears to be in appearance similar to wholegrain pasta (Macaroni B).

### Example 6

Macaroni's 4, D, E were prepared as described herein before in example 4, using the ingredients as indicated in Table 8.

TABLE 8

| Ingredients | 4 ¹ | | D | | E | |
|---|---|---|---|---|---|---|
| White pasta | 436 | g | — | | 436 | g |
| (Honig, NL) | | | | | | |
| Whole grain pasta | — | | 436 | g | — | |
| (Honig, NL) | | | | | | |
| Water used for boiling | 0.83 | L | 0.83 | L | 0.83 | L |
| (tap water, NL) | | | | | | |
| ‘Basis bouillon’ cube ² | 11.2 | g | 11.2 | g | 11.2 | g |
| (Knorr, NL) | | | | | | |

| | | | | |
|---|---|---|---|---|
| Dried aqueous Mulberry | 9.95 | g | — | — |
| (Morus alba) fruit extract ² | | | | |
| (Draco, US) | | | | |

¹Macaroni 4 was prepared by adding the bouillon cube and the mulberry extract to the cooking water
²This bouillon cube comprises about 46 wt. % NaCl, flavor enhancers (E621, E627, E631), palm oil, corn starch, maltodextrin, onion powder, sugar, yeast extract and flavoring ingredients such as garlic, selery seed, pepper, citric acid, concentrated vegetable juice (celery, carrot, leek, onion) and others.
³ This mulberry fruit extract comprises about:
2 wt.% of iminosugars comprising DNJ and GAL-DNJ;
20 wt.% of amino acids;
14 wt.% of organic acids;
22 wt.% of carbohydrates;
16 wt.% of ash;
Other compounds.

The different macaroni's thus prepared were tested by a professional sensory panel of 14 persons. The sensory panel tasted the different samples in random order and was unaware of how the samples were prepared. The sensory panel scored the different sensory attributes on a score scale of 0 to 15. The results are presented in table 9. The letters in table 9 are used to indicate the following. The values with the same letter are not statistically different from each other, while the values with different letters are statistically different from each other.

TABLE 9

| Sensory attributes | 4 | D | E |
|---|---|---|---|
| Bitter taste | 4.07 a | 3.24 b | 2.31 c |
| Sourdough/rye-bread odour | 6.52 a | 2.40 b | 0.55 c |
| Sourdough/rye-bread flavour | 6.43 a | 2.55 b | 0.62 c |
| Whole-wheat odour | 4.05 b | 6.19 a | 1.29 c |
| Whole-wheat flavour | 4.21 b | 6.45 a | 1.57 c |
| Flour flavour | 3.19 b | 3.98 b | 5.40 a |
| Fibrous mouthfeel | 3.36 b | 5.00 a | 1.36 c |
| Brown colour intensity | 9.07 a | 6.77 b | 3.63 c |
| Colour uniformity | 7.46 a | 4.81 b | 7.96 a |
| Rough appearance | 3.93 b | 5.90 a | 3.92 b |

The macaroni prepared with mulberry fruit extract in the cooking water (Macaroni 4) had several sensory attributes that were significantly changed compared to Macaroni E (white macaroni). These changed sensory attributes were at a level similar or were approaching a similar level as those tasted for Macaroni D (whole grain macaroni). The sensory attributes imparted by the bouillon cube ingredients, did not interfere with the sensory attributes imparted by the mulberry fruit extract.

1. A process of preparing a savoury concentrate, said process comprises the combining the following components:
a) 15-85% by weight of the savoury concentrate of inorganic salts;
b) 5-50% by weight of the savoury concentrate of a mulberry fruit material;
c) 0-60% by weight of the savoury concentrate of fat;
d) 0-25% by weight of the savoury concentrate of glutamate compound;
e) 0-25% by weight of the savoury concentrate of starch component selected from native starch, pre-gelatinised starch; maltodextrin, modified starch and combinations thereof;
f) 0-20% by weight of the savoury concentrate of sugars selected from monosaccharides, disaccharides and combinations thereof;
g) 0-45% by weight of the savoury concentrate of vegetable matter selected from vegetables, herbs, spices and combinations thereof;
h) 0-10% by weight of the savoury concentrate of water;
wherein the combination of components a) to e) is applied in an amount representing at least 55 wt. % of the weight of the savoury concentrate and wherein the combination of components a) to h) is applied in an amount representing at least 75 wt. % of the weight of the savoury concentrate.

2. Process according to claim 1, wherein the inorganic salts and the mulberry fruit material are applied in a weight ratio in the range of 1:4 to 20:1.

3. Process according to claim 1, wherein the mulberry fruit material comprises 0.1-15% by dry weight of the mulberry fruit material of iminosugars comprising 1-Deoxynojirimycin (DNJ).

4. Process according to claim 3, wherein the iminosugars further comprise one or more of fagomine, N-methyl-DNJ,1,4-dideoxy-1,4-imino-D-arabinitol (DAB), 2-O-α-D-galactopyranosyl-DNJ (GAL-DNJ), calystegin B.

5. Process according to claim 1, wherein the mulberry fruit material is obtained from the fruit of the Morus Alba, Morus nigra or Morus rubra.

6. Process according to claim 1, wherein the mulberry fruit material is a food-grade mulberry fruit extract, preferably an aqueous mulberry fruit extract.

7. Process according to claim 1, wherein the process yields a savoury concentrate in the form of particulate matter, wherein the process comprises combining:
a) 45-85% by weight of the savoury concentrate of inorganic salts;
b) 5-35% by weight of the savoury concentrate of mulberry fruit material;
c) 0.1-30% by weight of the savoury concentrate of fat;
d) 0.2-25% by weight of the savoury concentrate of glutamate compound;
e) 0.1-45% by weight of the savoury concentrate of vegetable matter selected from vegetables, herbs, spices and combinations thereof.

8. Process according to claim 1, wherein the process comprises converting the combined components into granules or shaped products.

9. Process according to claim 8, wherein the process yields a savoury concentrate in the form of a shaped product having a weight of 2-50 g, said process comprises combining:
a) 20-65% by weight of the shaped product of inorganic salts;
b) 10-50% by weight of the shaped product of mulberry fruit material;
c) 5-60% by weight of the shaped product of fat;
d) 0.2-25% by weight of the shaped product of glutamate compound;
e) 0.5-10% by weight of sugars selected from monosaccharides, disaccharides and combinations thereof.

10. Process according to claim 1, wherein the process comprises packaging of the savoury concentrate in a container, sachet or wrapper.

11. A savoury concentrate comprising the following components:
15-85% by weight of the savoury concentrate of inorganic salts;
5-50% by weight of the savoury concentrate of mulberry fruit material;
0-60% by weight of the savoury concentrate of fat;
0-25% by weight of the savoury concentrate of glutamate compound;
0-25% by weight of the savoury concentrate of starch component selected from native starch, pre-gelatinised starch, maltodextrin, modified starch and combinations thereof;
0-20% by weight of the savoury concentrate of sugars selected from monosaccharides, disaccharides and combinations thereof;
0-45% by weight of the savoury concentrate of vegetable matter selected from vegetables, herbs, spices and combinations thereof;
0-10% by weight of the savoury concentrate of water;
wherein the components a) to e) together represent at least 55 wt. % of the savoury concentrate and wherein the components a) to h) together represent at least 75 wt. % of the savoury concentrate.

12. Savoury concentrate according to claim 11, wherein the savoury concentrate is obtained by a process according to claim 1.

13. A method for preparing a cooked starch rich food product comprising at least 60% of starch by weight of dry matter, wherein said method comprises the addition of a savoury concentrate, according to claim 11, during or after the preparation of the cooked starch rich food product.

14. Method according to claim 1, wherein the method comprises adding the savoury concentrate in an amount of 0.01-7% by weight of the cooked starch rich food product.

15. A food kit comprising:
a savoury concentrate according to claim 11; and
a starch rich food product comprising at least 60% of starch by weight of dry matter of the starch rich food product.
